(19) United States
(12) Patent Application Publication
(10) Pub. No.: US 2025/0117974 A1
(43) Pub. Date: Apr. 10, 2025

(54) CONTROLLING COMPOSITION AND STRUCTURE IN GENERATED IMAGES

(71) Applicant: ADOBE INC., SAN JOSE, CA (US)

(72) Inventors: Midhun Harikumar, Sunnyvale, CA (US); Nicholas Isaac Kolkin, San Francisco, CA (US); Sachin Madhav Kelkar, Santa Clara, CA (US); Purvak Lapsiya, Toronto (CA); Elya Shechtman, Seattle, WA (US); Ajinkya Gorakhnath Kale, San Jose, CA (US); Jalansh Saumil Munshi, San Jose, CA (US)

(21) Appl. No.: 18/908,075

(22) Filed: Oct. 7, 2024

Related U.S. Application Data
(60) Provisional application No. 63/588,610, filed on Oct. 6, 2023.

(51) Int. Cl. G06T 11/00; G06F 40/284; G06T 5/70

(52) U.S. Cl. CPC G06T 11/00; G06F 40/284; G06T 5/70; G06T 2207/20081

(57) ABSTRACT

A method, apparatus, non-transitory computer readable medium, and system for generating synthetic images depicting an image element with a target composition include obtaining a content input and a composition input. The content input indicates an image element and the composition input indicates a target composition of the image element. Embodiments then encode the composition input to obtain a composition embedding representing the target composition. Subsequently, embodiments generate, using an image generation model, a synthetic image based on the content input and the composition embedding. The synthetic image depicts the image element with the target composition.

### CROSS-REFERENCE TO RELATED APPLICATION

This U.S. non-provisional application claims priority under 35 U.S.C. § 119 to U.S. Provisional Patent Application No. 63/588,610, filed on Oct. 6, 2023, in the United States Patent and Trademark Office, the disclosure of which is incorporated by reference herein in its entirety.

### BACKGROUND

The following relates generally to image processing, and more specifically to image generation. Image processing is a type of data processing that involves the manipulation of an image to get the desired output, typically utilizing specialized algorithms and techniques. It is a method used to perform operations on an image to enhance its quality or to extract useful information from it. This process usually comprises a series of steps that includes the importation of the image, its analysis, manipulation to enhance features or remove noise, and the eventual output of the enhanced image or salient information it contains.

Image processing techniques are also used for image generation. For example, machine learning (ML) techniques have been applied to create generative models that can produce new image content. One use for generative AI is to create images based on an input prompt. This task is often referred to as a “text to image” task or simply “text2img”. Some models such as GANs and Variational Autoencoders (VAEs) employ an encoder-decoder architecture with attention mechanisms to align various parts of text with image features. Newer approaches such as denoising diffusion probabilistic models (DDPMs) iteratively refine generated images in response to textual prompts. These models are typically used to produce images in the form of pixel data, which represents images as a matrix of pixels, where each pixel includes color information. There has been continued research into generative AI to discover new techniques for customizing the synthesized content.

### SUMMARY

Embodiments of the present inventive concepts include systems and methods for controlling the composition of generated images. Embodiments include an image processing apparatus that includes a composition encoder and an image generation model. The composition encoder is configured generate a composition embedding from a composition input which, when combined with the image generation model during image synthesis, imparts the generated content with a structure from the composition input. based on a composition input such as a depth map or a pose image. Embodiments of the image generation model are finetuned to learn of one or more image elements, such as an identity of an object or character, a lighting attribute, a texture attribute, a scene attribute, or the like. In some cases, the image element is referenced from a unique nonce token in the text prompt.

By using the composition encoder and the finetuned image generation model, embodiments are configured to synthesize images with one or more target image elements and with a structure from the composition input. According to some aspects, the composition encoder is trained independently of the image generation model, and in some cases, the composition encoder and the image generation model are each based on the same ancestor pre-trained model. In some embodiments, the image generation model includes a set of image element specific parameters that are trained, while remaining parameters are held fixed. This set of image element specific parameters may be swapped with another set to quickly set up a different custom image generation model with knowledge of other image elements.

A method, apparatus, non-transitory computer readable medium, and system for image generation are described. One or more aspects of the method, apparatus, non-transitory computer readable medium, and system include obtaining a content input and a composition input, wherein the content input indicates an image element and the composition input indicates a target composition of the image element; encoding the composition input to obtain a composition embedding representing the target composition; and generating, using an image generation model, a synthetic image based on the content input and the composition embedding, wherein the synthetic image depicts the image element with the target composition.

A method, apparatus, non-transitory computer readable medium, and system for image generation are described. One or more aspects of the method, apparatus, non-transitory computer readable medium, and system include obtaining a content input and a composition input, wherein the content input indicates an image element and the composition input indicates a target composition of the image element; encoding the composition input to obtain a composition embedding representing the target composition; and generating, using an image generation model, a synthetic image based on the content input and the composition embedding, wherein the synthetic image depicts the image element with the target composition.

An apparatus, system, and method for image generation are described. One or more aspects of the apparatus, system, and method include obtaining a content input and a composition input, wherein the content input indicates an image element and the composition input indicates a target composition of the image element; encoding the composition input to obtain a composition embedding representing the target composition; and generating, using an image generation model, a synthetic image based on the content input and the composition embedding, wherein the synthetic image depicts the image element with the target composition.

### BRIEF DESCRIPTION OF THE DRAWINGS

FIG. 1 shows an example of an image processing system according to aspects of the present disclosure.

FIG. 2 shows an example of an image processing apparatus according to aspects of the present disclosure.

FIG. 3 shows an example of a composition encoder according to aspects of the present disclosure.

FIG. 4 shows an example of a guided latent diffusion model according to aspects of the present disclosure.

FIG. 5 shows an example of a U-Net according to aspects of the present disclosure.

FIG. 6 shows an example of an image generation pipeline according to aspects of the present disclosure.

FIG. 7 shows an example of varying synthetic images based on the same input condition according to aspects of the present disclosure.

FIG. 8 shows an example of synthetic images using varying adherence parameters according to aspects of the present disclosure.

FIG. 9 shows an example of a method for providing a synthetic image to a user according to aspects of the present disclosure.

FIG. 10 shows an example of a method for reverse diffusion according to aspects of the present disclosure.

FIG. 11 shows an example of a method for generating a synthetic image of an image element with a target composition according to aspects of the present disclosure.

FIG. 12 shows an example of a training algorithm according to aspects of the present disclosure.

FIG. 13 shows an example of a method for training a diffusion model according to aspects of the present disclosure.

FIG. 14 shows an example of a method for training a composition encoder according to aspects of the present disclosure.

FIG. 15 shows an example of a computing device according to aspects of the present disclosure.

### DETAILED DESCRIPTION

In some cases, a creator or company may wish to create assets such as images and videos with a target image element, such as a human model placed in various poses, or a product placement in a particular lighting style. Conventional methods (aside, from e.g., conducting a manual re-shooting of the subject) utilize image editing tools to modify an existing model or product or to re-compose a product.

Some deep-learning models have explored face posing and other sketch to image generation such as StyleGAN, GauGAN and COMODGAN. These techniques produce relatively low-quality results and can lack fidelity to the original subject. Some of these techniques are also limited in their ability to quickly adapt to an unseen face or object and are limited to the domain they are trained for.

Diffusion models have proven to excel at reproducing realistic, high-quality images. Some methods for learning a particular image element, such as a face, finetuning the entire diffusion network. However, this process can cause the network to forget some of its previous training and does not generalize to new subjects easily. Further, these techniques do not allow defining a global composition.

Some methods attempt to add composition control using techniques such as SDEdit and Reverse DDIM to “invert” and image or composition into partial noise and re-generate the image with the customized object or person added. While these are structure preserving, they tend to leak attributes of the original structure image such as color, semantics and lighting.

Embodiments of the present disclosure, in contrast, improve the accuracy and generalizability of image generation models. Embodiments include an image processing apparatus trained to generate synthetic images with a particular image element such as a consistent style, product, or actor, with a target composition. The image processing apparatus is configured to receive a composition input, such as a depth map, an edge map, or pose information, which enables the system to compose the product or actor into predetermined poses and orientations. Embodiments include a composition encoder configured to encode the composition input to generate a composition embedding, which transfers structural information to an image generation model. The image generation model is finetuned to learn the particular image element, and to produce it when a unique nonce token or word(s) are invoked into a text prompt.

Embodiments of the composition encoder and the image generation model are independently trained from a common ancestor model, such as a pre-trained diffusion model. The image generation model may have hot-swappable parameters which are tuned to the specific knowledge of the image element. This allows embodiments to reproduce any particular element with the desired composition without the need to retrain either model.

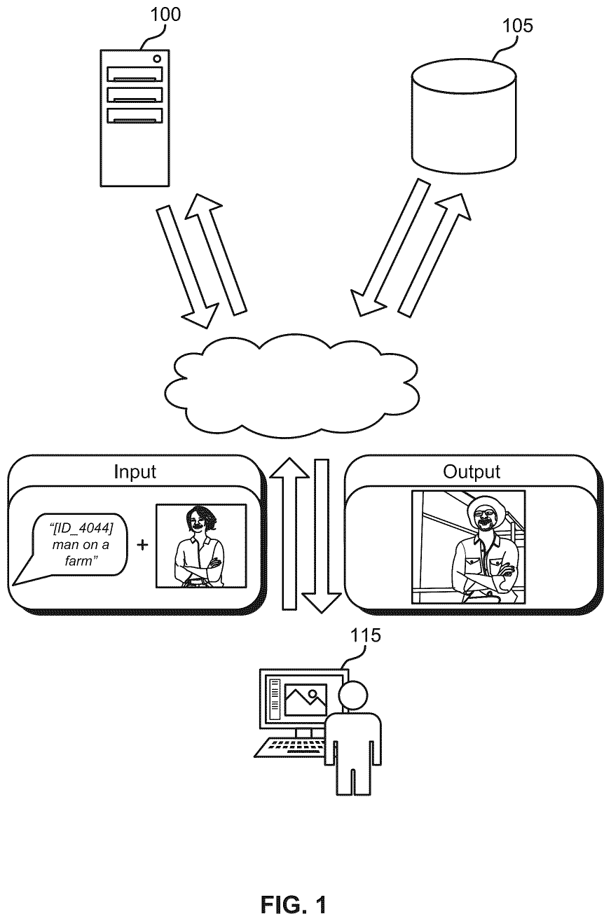

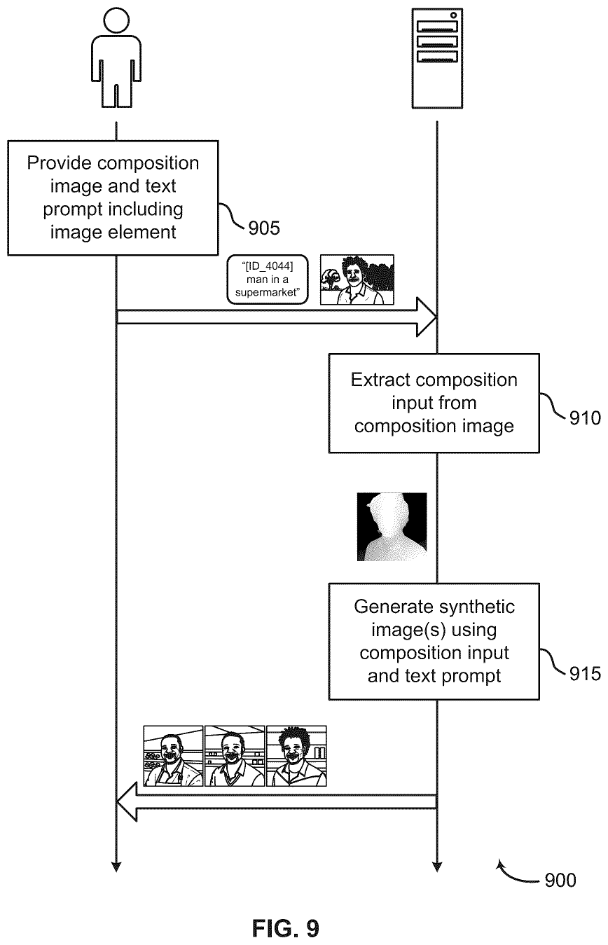

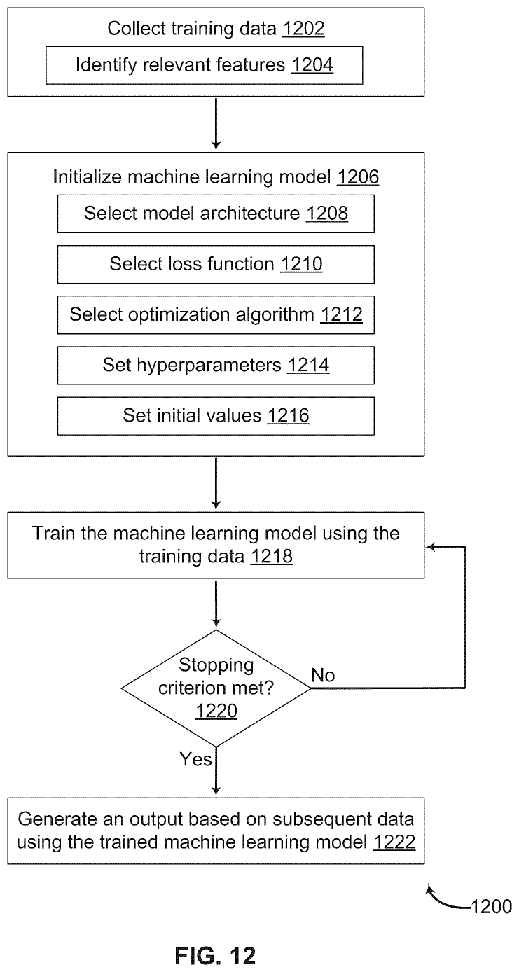

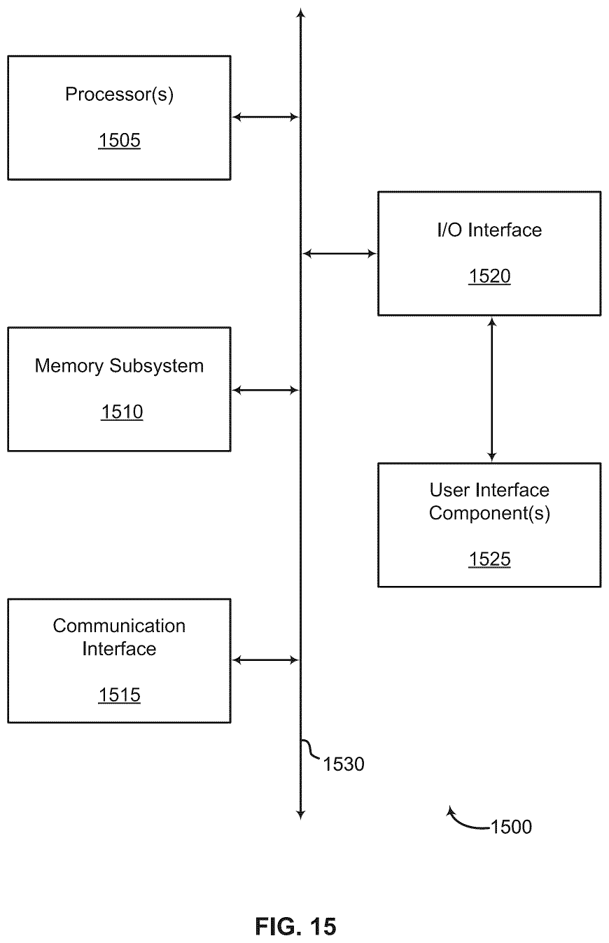

An image processing system is described with reference to FIGS. 1-8. Methods for generating synthetic images depicting an image element in a target composition are described with reference to FIGS. 9-11. Methods for training an image generation model and a composition encoder are described with reference to FIGS. 12-14. A computing device configured to implement an image processing apparatus is described with reference to FIG. 15.

### Image Processing System

FIG. 1 shows an example of an image processing system according to aspects of the present disclosure. The example shown includes image processing apparatus 100, database 105, network 110, and user interface 115.

In an example, a user provides a text prompt and a reference image. The text prompt may specify a target image element. For example, the text prompt may include a nonce token (which is referenced by the symbol [ID_4044] in FIG. 1), which represents the target image element. In this example, the image element is a human model. The reference image may be a compositional input such as a depth map or a pose image or may be a generic image from which the system extracts compositional information such as the depth map. In the example shown, the user provides a reference image of a different model in a pose with their arms crossed for use as the composition. Then, the image processing apparatus generates an image with the target image element indicated by ‘[ID_4044]’ with a composition from the reference image. In this case, the image processing apparatus generates an image depicting a particular identity/model learned by an image generation model of the image processing apparatus and referenced by the custom symbol, where the model is posed similar to the model provided in the user image.

Embodiments of image processing apparatus 100 are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a super computer, or any other suitable processing apparatus.

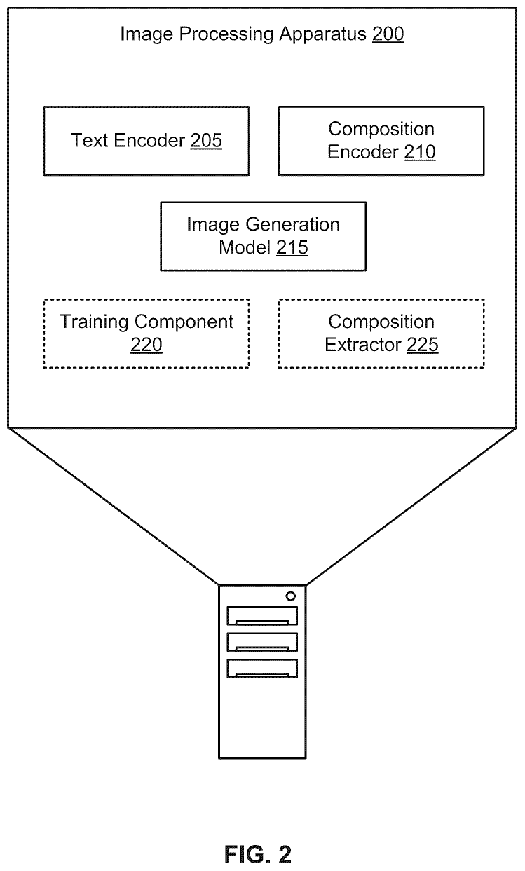

According to some aspects, image processing apparatus 100 obtains a content input and a composition input, where the content input indicates an image element, and the composition input indicates a target composition of the image element. In some aspects, the content input includes text describing the image element. In some aspects, the content input includes a nonce token representing the image element. In some aspects, the image element includes a style attribute, an identity of an object, a lighting attribute, a texture attribute, a scene attribute, or a combination thereof. In some examples, image processing apparatus 100 obtains an adherence factor input that indicates a level of adherence to the composition input, where the synthetic image is generated based on the adherence factor input. Image processing apparatus 100 is an example of, or includes aspects of, the corresponding element described with reference to FIG. 2.

Database 105 stores information used by the image generation system, such as training data, machine learning model parameters, finetuned hot-swappable parameters trained to encode knowledge of a particular image element, stock images, and the like. A database is an organized collection of data. For example, a database stores data in a specified format known as a schema. A database may be structured as a single database, a distributed database, multiple distributed databases, or an emergency backup database. In some cases, a database controller may manage data storage and processing in a database. In some cases, a user interacts with a database controller. In other cases, a database controller may operate automatically without user interaction.

Network 110 facilitates the transfer of information between image processing apparatus 100, database 105, and user interface 115. Network 110 may be referred as a “cloud”. A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

User interface 115 enables a user to interact with a device. In some embodiments, the user interface 115 may include an audio device, such as an external speaker system, an external display device such as a display screen, or an input device (e.g., a remote-control device interfaced with the user interface directly or through an IO controller module). In some cases, a user interface 115 may be a graphical user interface 115 (GUI). For example, the GUI may be a part of a web application, or a part of a program such as a multilayer design document editing software.

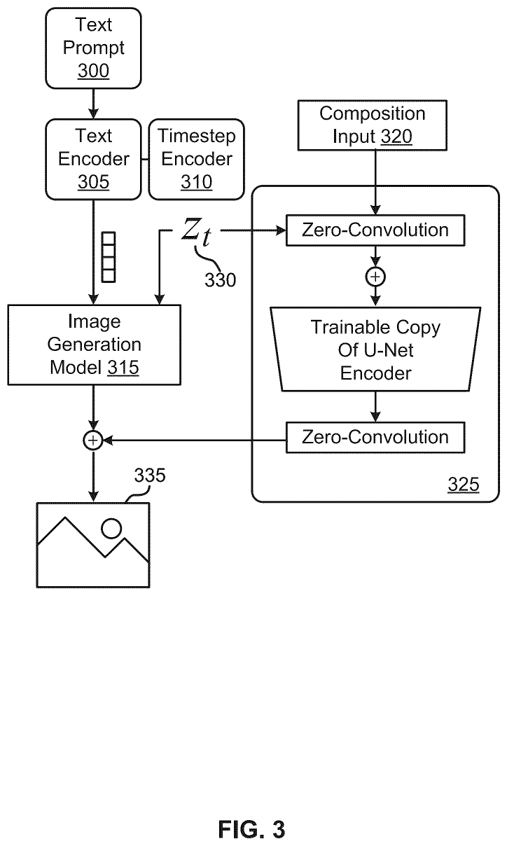

FIG. 2 shows an example of an image processing apparatus 200 according to aspects of the present disclosure. The example shown includes image processing apparatus 200, text encoder 205, composition encoder 210, image generation model 215, training component 220, and composition extractor 225. Image processing apparatus 200 is an example of, or includes aspects of, the corresponding element described with reference to FIG. 1. Text encoder 205 is an example of, or includes aspects of, the corresponding element described with reference to FIG. 3.

Embodiments of image processing apparatus 200 include several components and sub-components. These components are variously named and are described so as to partition the functionality enabled by the processor(s) and the executable instructions included in the computing device used to implement image processing apparatus 200 (such as the computing device described with reference to FIG. 15). The partitions may be implemented physically, such as through the use of separate circuits or processors for each component or may be implemented logically via the architecture of the code executable by the processors.

Components of the image processing apparatus 200 may be implemented using artificial neural networks (ANNs). An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

According to some aspects, text encoder 205 obtains a text prompt and encodes the text prompt to generate a text embedding. In some aspects, the text prompt includes a nonce token corresponding to the target image element. The nonce token may be, for example, a unique identifier that is recognizable by a tokenizer of the text encoder to lookup a particular token in a token vocabulary. The token may then be associated with a token embedding, a vector representation that encodes details about the image element associated with the nonce token. Embodiments of Text encoder 205 include a transformer-based encoder such as a Flan-T5 encoder or the text encoder used in a CLIP (Contrastive Language-Image Pre-training) model.

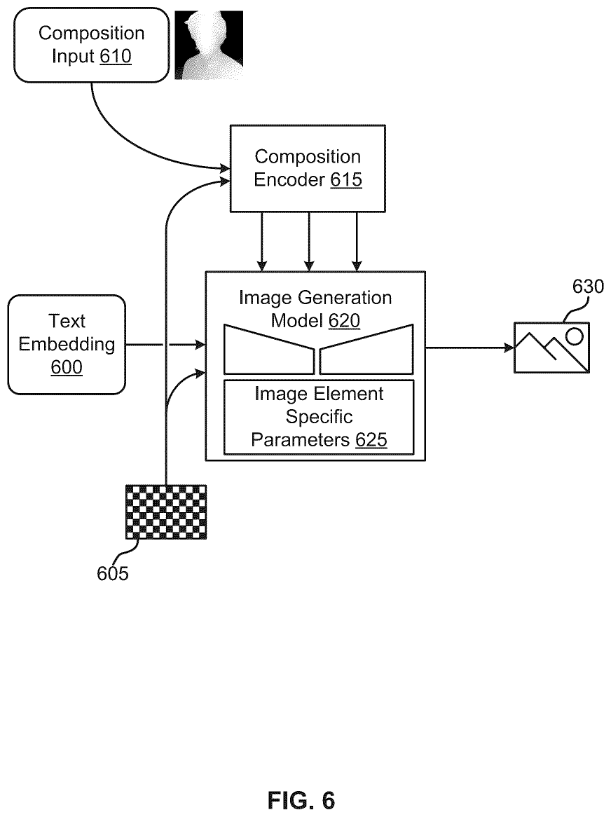

Composition encoder 210 is trained to generate a composition embedding from a composition input, such as a depth map. Embodiments of the composition encoder include a ControlNet based architecture. For example, the composition encoder may include a pretrained encoder block of a U-Net (e.g., the downsampling and middle blocks of the U-Net), as well as one or more zero convolution layers. The pretrained encoder block and the zero convolution layers may be finetuned during a training process to generate features from the composition input that can be combined with the features from image generation model 215 to impart structure into the generated image. The features may be combined, for example, by concatenating, adding, or averaging the features from the composition encoder 210 with the features from image generation model 215. In other words, according to some aspects, the features from composition encoder 210 do not touch or disrupt the cross-attention processes performed by image generation model 215. Additional detail about this process is provided with reference to FIG. 3. Composition encoder 210 is an example of, or includes aspects of, the corresponding element described with reference to FIGS. 3 and 6.

Image generation model 215 generates synthetic images based on text prompt. According to some aspects, the image generation model 215 may be influenced during its generation process by features output from composition encoder 210, such that the generated image includes the structure from an input composition. Embodiments of image generation model 215 include a diffusion model, though embodiments are not necessarily limited thereto.

According to some aspects, image generation model 215 generates a synthetic image based on the content input and the composition embedding, where the synthetic image depicts the image element with the target composition. In some examples, image generation model 215 obtains a noise map. In some examples, image generation model 215 denoises the noise map based on the content input and the composition embedding. In some aspects, the image generation model 215 is trained to generate images depicting the particular image element. Image generation model 215 is an example of, or includes aspects of, the corresponding element described with reference to FIGS. 3 and 6.

According to some aspects, composition extractor 225 obtains a composition image. In some examples, composition extractor 225 extracts the composition input from the composition image. The composition extractor may, for example, extract a depth or a pose or a mask or some other structural or compositional information from a reference image. The composition extractor 225 may do so using various computer vision techniques such as edge detection, artificial neural network (ANN)-based depth estimation, pose estimation through keypoint detection, semantic segmentation models, optical flow analysis for motion or structure extraction, or thresholding operations. The extracted information will then be input to composition encoder at inference time to ensure the composition is reproduced in the image generated by image generation model 215.

FIG. 3 shows an example of a composition encoder 325 according to aspects of the present disclosure. The example shown includes text prompt 300, text encoder 305, timestep encoder 310, image generation model 315, composition input 320, composition encoder 325, current noise map 330, and denoised noise map 335.

Text encoder 305 is an example of, or includes aspects of, the corresponding element described with reference to FIG. 2. Image generation model 315 is an example of, or includes aspects of, the corresponding element described with reference to FIGS. 2 and 6. Composition encoder 325 is an example of, or includes aspects of, the corresponding element described with reference to FIGS. 2 and 6.

In some embodiments, composition encoder 325 is based on a ControlNet architecture. ControlNet is a neural network structure to control image generation models by adding extra conditions. In some embodiments, a ControlNet architecture copies the weights from some of the neural network blocks of the image generation model to create a “locked” copy and a “trainable” copy. The “trainable” one learns to encode a condition. The “locked” copy (e.g., image generation model 315) preserves the parameters of the original model. The trainable copy can be tuned with a small dataset of image pairs, while preserving the locked copy ensures that the knowledge from the original model is preserved. In some embodiments, some of the parameters of image generation model 315 are unlocked during another training phase.

In some embodiments, one or more zero convolution layers are added to the trainable copy. A “zero convolution” layer is 1×1 convolution with both weight and bias values initialized as zeros. Before training, the zero convolution layers output all zeros; accordingly, there is no initial contribution from the composition encoder 325 before training. This prevents noise from influencing the outputs of image generation model 315 at the beginning of training. As the training proceeds, the parameters of the zero convolution layers deviate from zero and the influence of the composition encoder 325 on the output grows.

According to some aspects, composition encoder 325 receives a composition input 320. The composition input may be, e.g., a direct representation of a composition such as an image or may be a transformed representation such as a feature set produced by another encoding layer. In some cases, composition encoder 325 further receives current noise map 330, e.g., zₜ. In some cases, the composition input 320 is combined with the input before being applied to the trainable encoder blocks within the composition encoder 325.

According to some aspects, the features produced by composition encoder 325 are combined with the features produced by image generation model 315 as shown by the “+” block. The features may be combined via addition or concatenation. According to some aspects, the features from composition encoder 325 do not adjust or interfere with the cross-attention operations performed by image generation model 315.

In some embodiments, the features from composition encoder 325 combined with the outputs from the middle and the decoding blocks of the image generation model 315 as illustrated in FIG. 3. In some cases, the output from composition encoder 325 is masked in certain regions so that only some regions are constrained by the output. In an example, if a user wants to hold the torso of a person at a particular pose and allow the legs to be freely generated, the user can specify a mask that only applies the composition encoder output to the upper part of the body.

According to some aspects, the text prompt 300 is encoded by text encoder 305, and the resulting text embedding is applied to image generation model 315 as guidance features. In some cases, the time (e.g., diffusion timestep) is additionally provided to image generation model 315. In some cases, the text embedding is also applied to composition encoder 325, though not in all embodiments.

The outputs of image generation model 315 are then combined with the outputs of composition encoder 325 to yield denoised noise map 335. When the image generation model 315 and the composition encoder 325 are based on diffusion processes, the denoised noise map 335 may be used as the current noise map 330 in the next generative iteration.

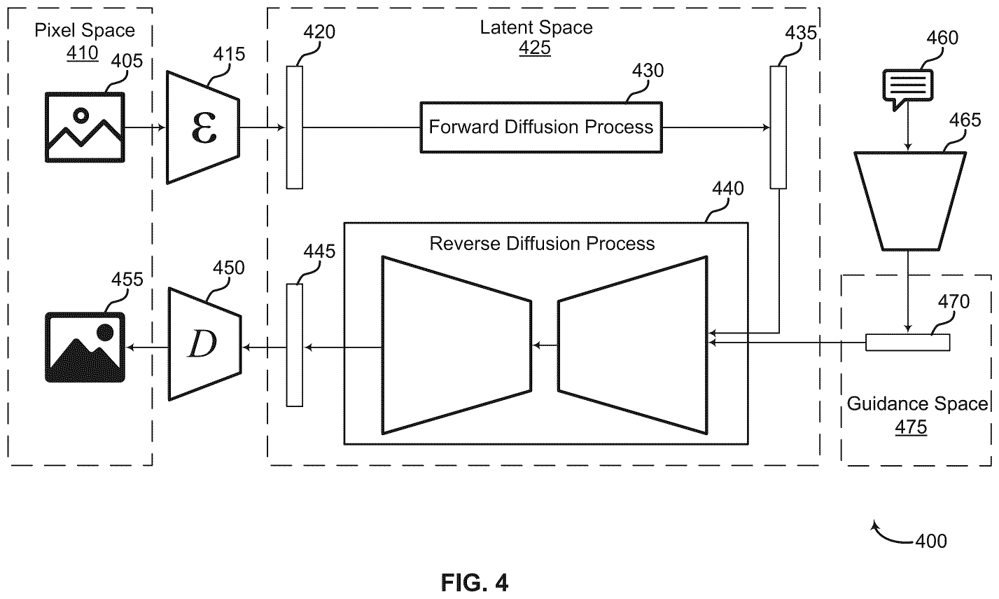

FIG. 4 shows an example of a guided latent diffusion model 400 according to aspects of the present disclosure. The guided latent diffusion model 400 depicted in FIG. 4 is an example of, or includes aspects of, the image generation model 215 described with reference to FIG. 2.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 400 may take an original image 405 in a pixel space 410 as input and apply and image encoder 415 to convert original image 405 into original image features 420 in a latent space 425. Then, a forward diffusion process 430 gradually adds noise to the original image features 420 to obtain noisy features 435 (also in latent space 425) at various noise levels.

Next, a reverse diffusion process 440 (e.g., a U-Net ANN) gradually removes the noise from the noisy features 435 at the various noise levels to obtain denoised image features 445 in latent space 425. In some examples, the denoised image features 445 are compared to the original image features 420 at each of the various noise levels, and parameters of the reverse diffusion process 440 of the diffusion model are updated based on the comparison. Finally, an image decoder 450 decodes the denoised image features 445 to obtain an output image 455 in pixel space 410. In some cases, an output image 455 is created at each of the various noise levels. The output image 455 can be compared to the original image 405 to train the reverse diffusion process 440.

In some cases, image encoder 415 and image decoder 450 are pre-trained prior to training the reverse diffusion process 440. In some examples, they are trained jointly, or the image encoder 415 and image decoder 450 and fine-tuned jointly with the reverse diffusion process 440.

The reverse diffusion process 440 can also be guided based on a text prompt 460, or another guidance prompt, such as an image, a layout, a segmentation map, etc. The text prompt 460 can be encoded using a text encoder 465 (e.g., a multimodal encoder) to obtain guidance features 470 in guidance space 475. The guidance features 470 can be combined with the noisy features 435 at one or more layers of the reverse diffusion process 440 to ensure that the output image 455 includes content described by the text prompt 460. For example, guidance features 470 can be combined with the noisy features 435 using a cross-attention block within the reverse diffusion process 440.

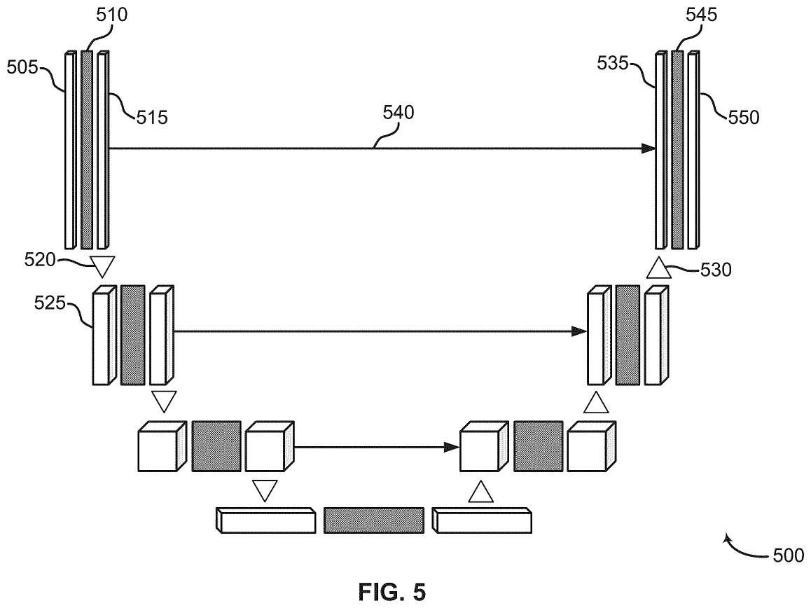

FIG. 5 shows an example of a U-Net 500 according to aspects of the present disclosure. In some examples, U-Net 500 is an example of the component that performs the reverse diffusion process 440 of guided diffusion model 400 described with reference to FIG. 4 and includes architectural elements of the image generation model 215 and the composition encoder 210 as described with reference to FIG. 2. For example, the image generation model 215 may include a full U-Net, that is, encoder (downsampling and middle) blocks and decoder (upsampling) blocks. The composition encoder 210 may include only the encoder blocks. The U-Net 500 depicted in FIG. 5 is an example of, or includes aspects of, the architecture used within the reverse diffusion process described with reference to FIG. 3.

In some examples, diffusion models are based on a neural network architecture known as a U-Net. The U-Net 500 takes input features 505 having an initial resolution and an initial number of channels and processes the input features 505 using an initial neural network layer 510 (e.g., a convolutional network layer) to produce intermediate features 515. The intermediate features 515 are then down-sampled using a down-sampling layer 520 such that down-sampled features 525 have a resolution less than the initial resolution and a number of channels greater than the initial number of channels.

This process is repeated multiple times, and then the process is reversed. That is, the down-sampled features 525 are up-sampled using up-sampling process 530 to obtain up-sampled features 535. The up-sampled features 535 can be combined with intermediate features 515 having a same resolution and number of channels via a skip connection 540. These inputs are processed using a final neural network layer 545 to produce output features 550. In some cases, the output features 550 have the same resolution as the initial resolution and the same number of channels as the initial number of channels.

In some cases, U-Net 500 takes additional input features to produce conditionally generated output. For example, the additional input features could include a vector representation of an input prompt. The additional input features can be combined with the intermediate features 515 within the neural network at one or more layers. For example, a cross-attention module can be used to combine the additional input features and the intermediate features 515.

FIG. 6 shows an example of an image generation pipeline according to aspects of the present disclosure. The example shown includes text embedding 600, noise map 605, composition input 610, composition encoder 615, image generation model 620, image element specific parameters 625, and synthetic image 630. In one aspect, image generation model 620 includes image element specific parameters 625. In some cases, image element specific parameters 625 of image generation model 620 are finetuned in a training process while other parameters image generation model 620 are fixed. The image element specific parameters may be, for example, parameters of the cross-attention layers of the image generation model. In some cases, the image element specific parameters 625 are swapped out for different parameters to achieve a different set of target image elements. According to some aspects, composition encoder 615 can be swapped out as well to provide an encoder that enforces a particular structural condition or some other condition in synthetic image 630. Composition encoder 615 and image generation model 620 are examples of, or include aspects of, the corresponding elements described with reference to FIGS. 2 and 3.

In this example, a text embedding 600 is input to an image generation model 620. In some cases, the text embedding 600 is generated based on an input text by a text encoder such as the one described with reference to FIG. 2. According to some aspects, the text embedding 600 includes a nonce token, e.g., a token from a tokenizer vocabulary that is associated with a vector representation that was learned during a training phase of the system. The vector representation encodes attributes of the image element associated with the nonce token. The nonce token may be referenced by a particular symbol in the text prompt.

Composition input 610 is input to composition encoder 615. Composition input 610 may include, for example, a depth map as illustrated in FIG. 6. Embodiments are not limited thereto, however, and the composition input 610 may include an edge map, pose information, layout information, or some other information that specifies a structure. Composition encoder 615 encodes the composition condition to generate a composition embedding. According to some aspects, the encoding is performed different resolutions (e.g., in accordance with the downsampling structure of the encoder portion of the U-Net), and outputs from each resolution are combined with features from image generation model 620.

Image generation model 620 generates synthetic image 630 based on the composition embedding, the text embedding 600, and noise map 605. According to some aspects, the image generation model 620 initializes noise map 605 as a noise image or noise vector. Noise map 605 may then be iteratively processed to remove noise and generate an image. In some embodiments, image generation model includes image element specific parameters 625, which is a configuration of the image generation model 620 (e.g., a state of the image generation model 620 after a finetuning phase) that enables the image generation model 620 to produce a specific image element. The specific image element may be associated with a nonce token from a token vocabulary as described above. According to some aspects, the image element specific parameters 625 are parameters from a cross-attention block of the image generation model 620.

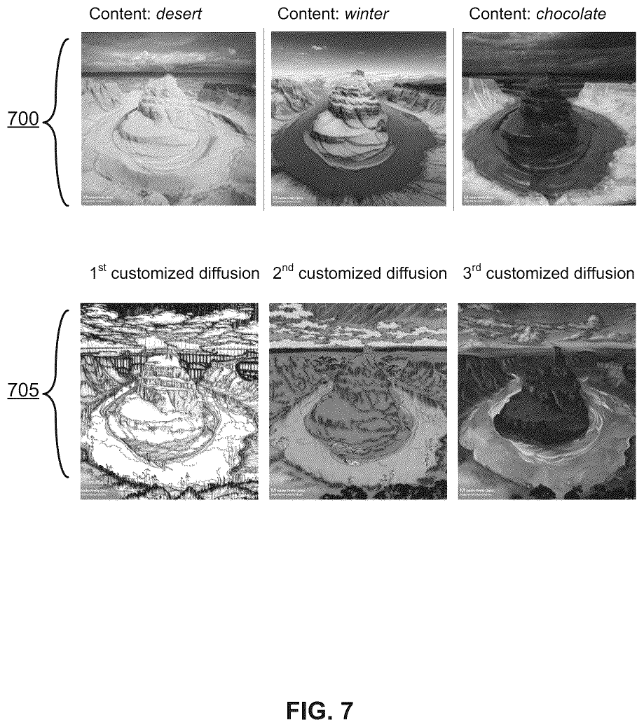

FIG. 7 shows an example of varying synthetic images based on the same input condition according to aspects of the present disclosure. The example shown includes outputs with varying content inputs 700 and outputs with varying image element specific parameters 705.

For example, outputs with varying content inputs 700 includes 3 images, each generated with the same composition input, but with different content inputs (e.g., text prompts). The composition input may be, for example, an edge map of a spiraling mountain. The 3 images are generated with different text prompts. For example, the leftmost image may be generated with a text prompt that includes “desert”, the middle image may be generated with a text prompt that includes “winter”, and the rightmost image may be generated with a text prompt that includes “chocolate.” Accordingly, embodiments allow a user to generate images with different contents but with a similar overall structure.

The outputs with varying image element specific parameters 705 also includes 3 images. The three images may be generated with the same composition input, such as the edge map of a spiraling mountain composition input used to generate the topmost images. The three images may also have the same corresponding text prompts as the images directly above them. However, each of the three images may include an image generation model with image element specific parameters that tuned for a different target image element. In this example, the image element is not referenced by a nonce token, but instead is embedded for all content inputs. For example, the leftmost image of outputs with varying image element specific parameters 705 may be generated by an image generation model that is tuned with the knowledge of a stylistic image element for a line-drawing style. The middle image may be generated by an image generation model with a “Japanese painting” stylistic image element, and the rightmost image may be generated with a target stylistic image element in the style of, e.g., a past artist. Accordingly, embodiments allow a user to generate images with different styles, but with a similar overall structure.

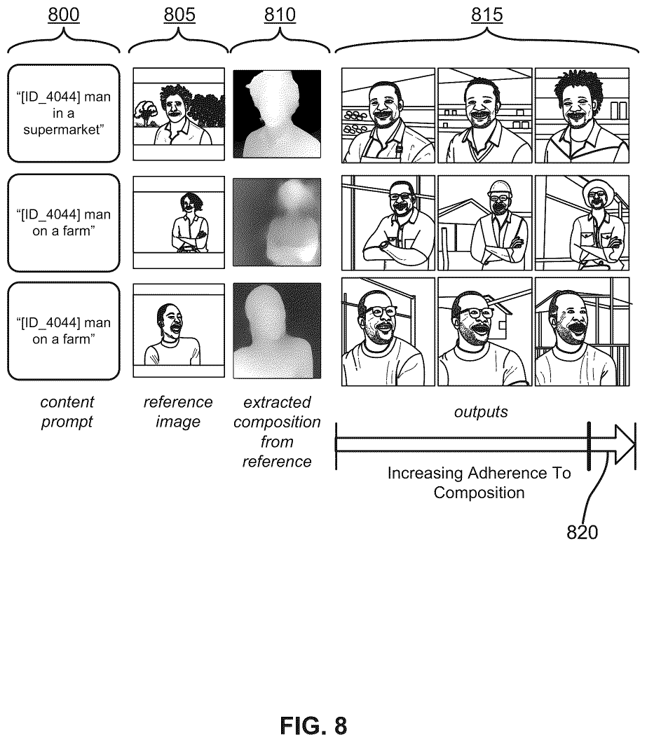

FIG. 8 shows an example of synthetic images 815 using varying adherence parameters according to aspects of the present disclosure. The example shown includes text prompts 800, composition images 805, extracted composition inputs 810, synthetic images 815, and adherence parameter slider 820.

In this example, each of text prompts 800 includes an identifier “[ID_4044]” which represents an identity of a model that is stored implicitly within the parameters of a finetuned image generation model. Accordingly, all 3 results will reproduce the identity. In these examples, extracted composition inputs 810 include depth maps extracted from reference images 805. In this example, synthetic images 815 are arranged from left to right with an increasing adherence parameter.

The image processing system may receive the adherence parameter from a user via the and adherence parameter slider 820. The adherence parameter may control an adherence of the generated image to the composition input. For example, the adherence parameter may determine a scaling factor or a weighted sum factor that is applied to the features obtained from the condition embedding. In this example, in the first row, the structure of the hair of the man in the reference image begins to appear in the synthetic image as the adherence parameter increases in value. Furthermore, the shirt of the man in the reference image begins to be more faithfully represented in its structure. In the last row, with a large adherence parameter, the glasses of the model disappear to more closely adhere to the no-glasses shape of the woman in the reference image.

FIG. 9 shows an example of a method 900 for providing a synthetic image to a user according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 905, a user provides a composition image and a text prompt including an image element. The composition image depicts a desired structure; for example, a desired pose. The text prompt in this example includes the image element as a nonce token, which is a keyword that causes a text encoder of the system to directly access a token embedding representing the image element.

At operation 910, the system extracts a composition input from the composition image. The system may do so via a composition extractor as described with reference to FIG. 2. For example, the composition extractor may extract a depth map from the composition image using computer vision techniques such as an ANN-based depth extractor.

At operation 915, the system generates synthetic image(s) using the composition input and the text prompt. For example, a composition encoder such as the one described with reference to FIGS. 2-3 may generate a composition embedding from the composition input. This composition embedding may be combined with outputs from the image generation model during a reverse diffusion process to generate the synthetic image(s). Additional detail regarding image generation techniques are described with reference to FIGS. 3-5 and FIG. 10.

### Generating Synthetic Images

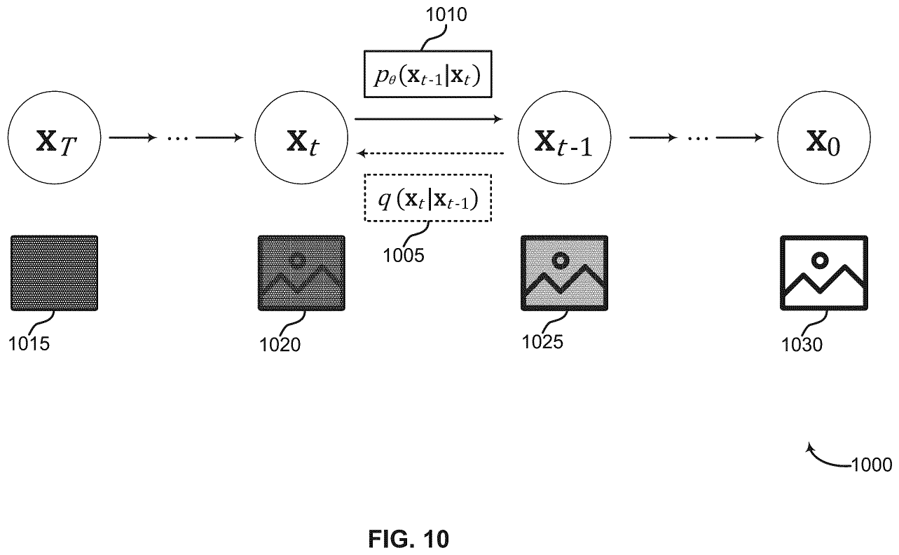

FIG. 10 shows a diffusion process 1000 according to aspects of the present disclosure. In some examples, diffusion process 1000 describes an operation of the image generation model 215 described with reference to FIG. 2, such as the reverse diffusion process 440 of guided latent diffusion model 400 described with reference to FIG. 4.

As described above with reference to FIG. 4, using a diffusion model can involve both a forward diffusion process 1005 for adding noise to an image (or features in a latent space) and a reverse diffusion process 1010 for denoising the images (or features) to obtain a denoised image. The forward diffusion process 1005 can be represented as q(xₜ|xₜ₋₁), and the reverse diffusion process 1010 can be represented as p(xₜ₋₁|xₜ). In some cases, the forward diffusion process 1005 is used during training to generate images with successively greater noise, and a neural network is trained to perform the reverse diffusion process 1010 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1010, the model begins with noisy data x_{T}, such as a noisy image 1015 and denoises the data to obtain the p(xₜ₋₁|xₜ). At each step t−1, the reverse diffusion process 1010 takes xₜ, such as first intermediate image 1020, and t as input. Here, t represents a step in the sequence of transitions associated with different noise levels, The reverse diffusion process 1010 outputs xₜ₋₁, such as second intermediate image 1025 iteratively until x_{T} reverts back to x₀, the original image 1030. The reverse process can be represented as:

$${p}_{θ} ( {x}_{t - 1} \vert {x}_{t} ) : = N ( {x}_{t - 1} ; {μ}_{θ} ( {x}_{t} , t ) , {Σ}_{θ} ( {x}_{t} , t ) ) \qquad ( 1 )$$

The joint probability of a sequence of samples in the Markov chain can be written as a product of conditionals and the marginal probability:

$${x}_{T} : {p}_{θ} ( {x}_{0 : T} ) : = p ( {x}_{T} ) {Π}_{t = 1}^{T} {p}_{θ} ( {x}_{t - 1} \vert {x}_{t} ) \qquad ( 2 )$$

where p(x_{T})=N(x_{T}; 0, I) is the pure noise distribution as the reverse process takes the outcome of the forward process, a sample of pure noise, as input and Πₜ₌₁^{T}p_{θ}(xₜ₋₁|xₜ) represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

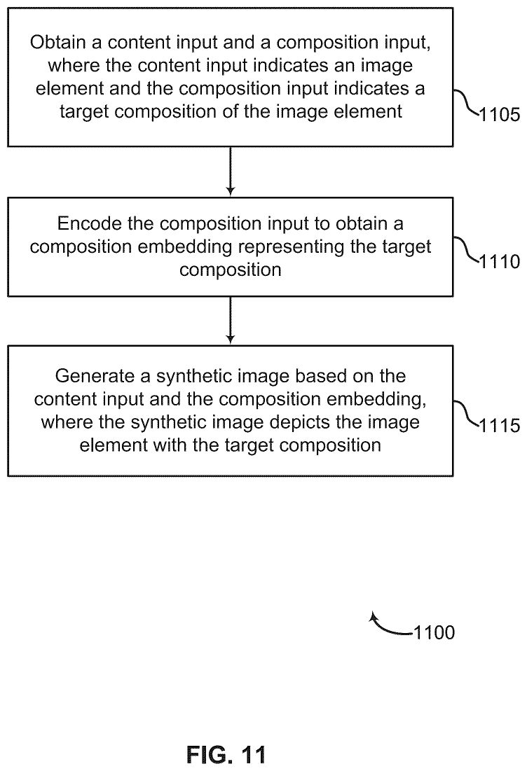

FIG. 11 shows an example of a method 1100 for generating a synthetic image of an image element with a target composition according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1105, the system obtains a content input and a composition input, where the content input indicates an image element and the composition input indicates a target composition of the image element. In some cases, the operations of this step refer to, or may be performed by, an image processing apparatus as described with reference to FIGS. 1 and 2. For example, the system may obtain the content input as a text prompt via a user interface as described with reference to FIG. 1. The system may further obtain the composition input via the user interface. Examples of a composition input include depth map, an edge map, pose information, layout information, or any combination thereof. In some cases, a user may provide a composition image, and the system may extract the composition input therefrom using a composition extractor as described with reference to FIG. 2.

At operation 1110, the system encodes the composition input to obtain a composition embedding representing the target composition. In some cases, the operations of this step refer to, or may be performed by, a composition encoder as described with reference to FIGS. 2, 3, and 6. A detailed description of the composition encoder is provided with reference to FIG. 3.

At operation 1115, the system generates a synthetic image based on the content input and the composition embedding, where the synthetic image depicts the image element with the target composition. In some cases, the operations of this step refer to, or may be performed by, an image generation model as described with reference to FIGS. 2, 3, and 6. The image generation model may perform a reverse diffusion process to generate intermediate features of the synthetic image in the form of a denoised noise map. These intermediate features may be combined with composition features from the composition encoder at each generative iteration, before being passed to the next generative iteration until the sample is fully denoised. The fully denoised sample may be decoded from a latent space to obtain the synthetic image.

### Training Methods

FIG. 12 is a flow diagram depicting an algorithm as a step-by-step procedure 1200 in an example implementation of operations performable for training a machine-learning model. In some embodiments, the procedure 1200 describes an operation of the training component 220 described for configuring the image model 215 and the composition encoder 210 as described with reference to FIG. 2. The procedure 1200 provides one or more examples of generating training data, use of the training data to train a machine-learning model, and use of the trained machine-learning model to perform a task.

To begin in this example, a machine-learning system collects training data (block 1202) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1204) to a type of task, for which, the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1206). Initialization of the machine-learning model includes selecting a model architecture (block 1208) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1210). The loss function is utilized to measure a difference between an output of the machine-learning model (i.e., predictions) and target values (e.g., as expressed by the training data) to be used to train the machine-learning model. Additionally, an optimization algorithm is selected (1212) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1214) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1218) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1220), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1220), the procedure 1200 continues training of the machine-learning model using the training data (block 1218) in this example.

If the stopping criterion is met (“yes” from decision block 1220), the trained machine-learning model is then utilized to generate an output based on subsequent data (block 1222). The trained machine-learning model, for instance, is trained to perform a task as described above and therefore once trained is configured to perform that task based on subsequent data received as an input and processed by the machine-learning model.

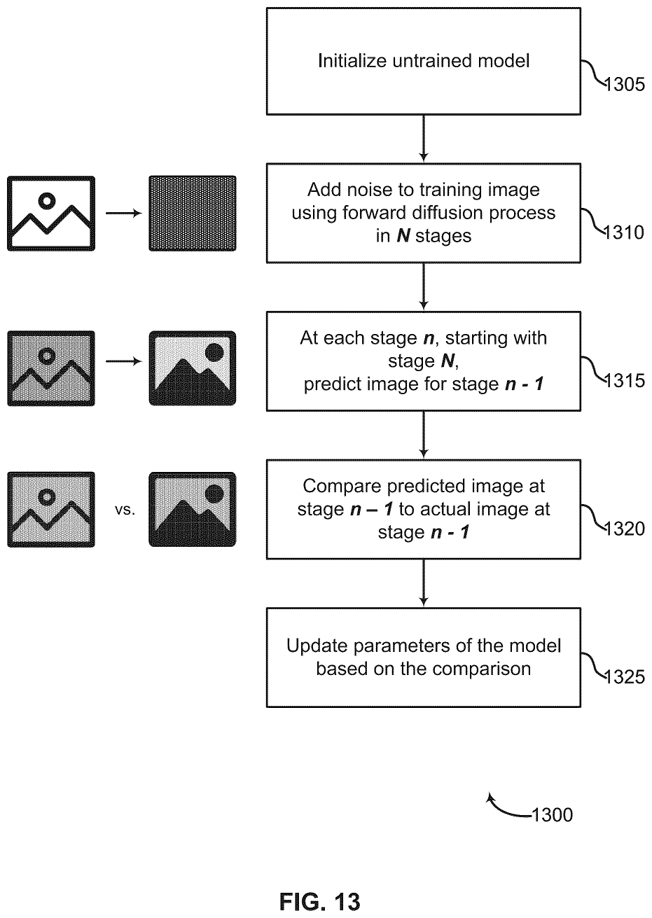

FIG. 13 shows an example of a method 1300 for training a diffusion model according to aspects of the present disclosure. In some embodiments, the method 1300 describes an operation of the training component 220 described for configuring the image generation model 215 as described with reference to FIG. 2. The method 1300 represents an example for training a reverse diffusion process as described above with reference to FIGS. 4 and 10. In some examples, these operations are performed by a system including a processor executing a set of codes to control functional elements of an apparatus, such as the guided latent diffusion model described in FIG. 4.

Additionally or alternatively, certain processes of method 1300 may be performed using special-purpose hardware. Generally, these operations are performed according to the methods and processes described in accordance with aspects of the present disclosure. In some cases, the operations described herein are composed of various substeps or are performed in conjunction with other operations.

At operation 1305, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1310, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 1315, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 1320, the system compares predicted image (or image features) at stage n−1 to an actual image (or image features), such as the image at stage n−1 or the original input image. For example, given observed data x, the diffusion model may be trained to minimize the variational upper bound of the negative log-likelihood-log p_{θ}(x) of the training data.

At operation 1325, the system updates parameters of the model based on the comparison. For example, parameters of a U-Net may be updated using gradient descent. Time-dependent parameters of the Gaussian transitions can also be learned.

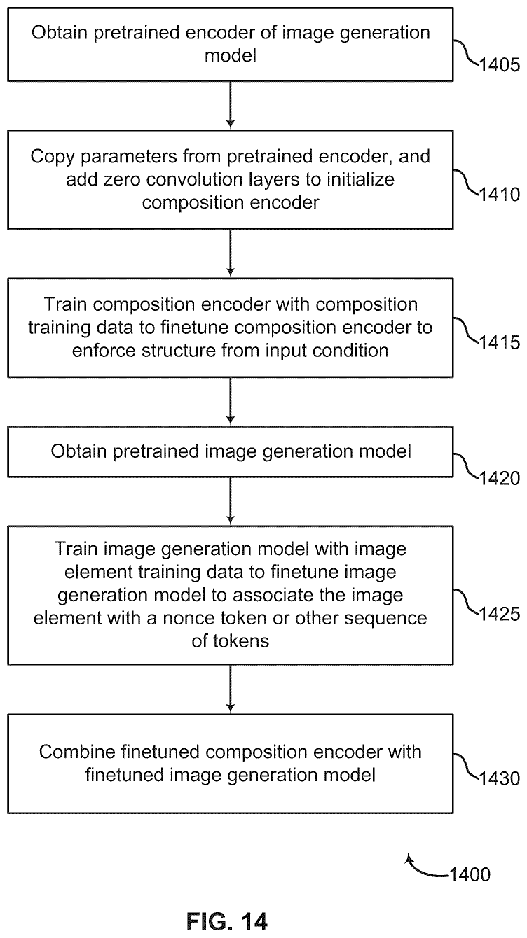

FIG. 14 shows an example of a method 1400 for training a composition encoder according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1405, the system obtains pretrained encoder of image generation model. For example, the system may obtain a pretrained guided latent diffusion model configured to generate realistic images. The system may then partition the downsampling blocks and the middle block from the pretrained guided latent diffusion model to obtain the pretrained encoder.

At operation 1410, the system copies parameters from the pretrained encoder, and adds zero convolution layers to initialize a composition encoder. According to some aspects, the composition encoder includes a first zero convolution layer at the front, followed by the pretrained encoder, followed by second zero convolution layer at the end of the network. Additional detail regarding the composition encoder is provided with reference to FIG. 3.

At operation 1415, the system trains the composition encoder with composition training data, such as depth maps, pose information, or edge maps, to finetune the encoder. The training process adjusts the composition encoder's parameters to generate features that represent the compositional structure encoded in the input condition. The training process gradually teaches the composition encoder to interpret structural information from the composition input and to generate a composition embedding (composition features) therefrom. The composition features may be merged through operations like addition or concatenation at various stages of the U-Net architecture of the image generation model without interfering with the cross-attention mechanisms of the image generation model that handle semantic information derived from the text prompt.

At operation 1420, the system obtains pretrained image generation model. This may be the same pretrained image generation model that is obtained in operation 1405.

At operation 1425, the system trains image generation model with image element training data to finetune image generation model to associate the image element with a nonce token or other sequence of tokens. According to some aspects, the system finetunes cross-attention layers of the image generation model with image element training data according to the process described with reference to FIG. 13. The cross-attention layers may be saved into a database and hot-swapped into another image generation model so as to quickly enable other image generation models to reproduce the image element.

At operation 1430, the system combines finetuned composition encoder with finetuned image generation model. This creates the system as described with reference to FIG. 3, which is configured to generate synthetic images of a particular image element with the composition from a composition input.

FIG. 15 shows an example of a computing device 1500 according to aspects of the present disclosure. The example shown includes computing device 1500, processor(s) 1505, memory subsystem 1510, communication interface 1515, I/O interface 1520, user interface component(s), and channel 1530.

In some embodiments, computing device 1500 is an example of, or includes aspects of, a design personalization apparatus as described in FIGS. 1 and 2. In some embodiments, computing device 1500 includes one or more processors 1505 are configured to execute instructions stored in memory subsystem 1510 to obtain a content input and a composition input, wherein the content input indicates an image element and the composition input indicates a target composition of the image element; encode the composition input to obtain a composition embedding representing the target composition; and generate, using an image generation model, a synthetic image based on the content input and the composition embedding, wherein the synthetic image depicts the image element with the target composition.

According to some aspects, computing device 1500 includes one or more processors 1505. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1515 operates at a boundary between communicating entities (such as computing device 1500, one or more user devices, a cloud, and one or more databases) and channel 1530 and can record and process communications. In some cases, communication interface 1515 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1520 is controlled by an I/O controller to manage input and output signals for computing device 1500. In some cases, I/O interface 1520 manages peripherals not integrated into computing device 1500. In some cases, I/O interface 1520 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1520 or via hardware components controlled by the I/O controller.

According to some aspects, user interface component(s) 1525 enable a user to interact with computing device 1500. In some cases, user interface component(s) 1525 include an audio device, such as an external speaker system, an external display device such as a display screen, an input device (e.g., a remote-control device interfaced with a user interface directly or through the I/O controller), or a combination thereof. In some cases, user interface component(s) 1525 include a GUI.

Accordingly, the present disclosure includes the following aspects.

A method for image generation is described. One or more aspects of the method include obtaining a content input and a composition input, wherein the content input indicates an image element and the composition input indicates a target composition of the image element; encoding the composition input to obtain a composition embedding representing the target composition; and generating, using an image generation model, a synthetic image based on the content input and the composition embedding, wherein the synthetic image depicts the image element with the target composition.

In some aspects, the content input comprises text describing the image element. In some aspects, the composition embedding is based on the content input. For example, some embodiments condition the generation of the composition using an embedding of the content input. In some aspects, the content input comprises a nonce token representing the image element. Additional detail regarding the nonce token is provided with reference to FIG. 2.

Some examples of the method, apparatus, non-transitory computer readable medium, and system further include obtaining a noise map. Some examples further include denoising the noise map based on the content input and the composition embedding. In some aspects, the composition input comprises a depth map, an edge map, pose information, layout information, or any combination thereof. In some aspects, the image element comprises a style attribute, an identity of an object, a lighting attribute, a texture attribute, a scene attribute, or a combination thereof.

Some examples of the method, apparatus, non-transitory computer readable medium, and system further include obtaining a composition image. Some examples further include extracting the composition input from the composition image. Some examples of the method, apparatus, non-transitory computer readable medium, and system further include generating the content input based on the composition image. For example, the content input may be generated by a captioning component that includes a captioning model that associates visual data with text, such as CLIP, BLIP-2, or similar. Some examples of the method, apparatus, non-transitory computer readable medium, and system further include obtaining an adherence factor input that indicates a level of adherence to the composition input, wherein the synthetic image is generated based on the adherence factor input.

An apparatus for image generation is described. One or more aspects of the apparatus include obtaining a content input and a composition input, wherein the content input indicates an image element and the composition input indicates a target composition of the image element; encoding the composition input to obtain a composition embedding representing the target composition; and generating, using an image generation model, a synthetic image based on the content input and the composition embedding, wherein the synthetic image depicts the image element with the target composition.

Some examples of the apparatus, system, and method further include a text encoder configured to generate a text embedding based on the content input. In some aspects, the image generation model is trained to generate images having a plurality of different image elements based on a plurality of different nonce tokens, respectively. In some aspects, the composition encoder comprises a ControlNet.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a content input and a composition input, wherein the content input indicates an image element and the composition input indicates a target composition of the image element;
encoding the composition input to obtain a composition embedding representing the target composition; and
generating, using an image generation model, a synthetic image based on the content input and the composition embedding, wherein the synthetic image depicts the image element with the target composition.

2. The method of claim 1, wherein:
the content input comprises text describing the image element.

3. The method of claim 1, wherein:
the composition embedding is based on the content input.

4. The method of claim 1, wherein:
the content input comprises a nonce token representing the image element.

5. The method of claim 1, wherein generating the synthetic image comprises:
obtaining a noise map; and
denoising the noise map based on the content input and the composition embedding.

6. The method of claim 1, wherein:
the composition input comprises a depth map, an edge map, pose information, layout information, or any combination thereof.

7. The method of claim 1, wherein:
the image element comprises a style attribute, an identity of an object, a lighting attribute, a texture attribute, a scene attribute, or a combination thereof.

8. The method of claim 1, wherein:
the image generation model is trained to generate images depicting the image element.

9. The method of claim 1, wherein obtaining the composition input comprises:
obtaining a composition image; and
extracting the composition input from the composition image.

10. The method of claim 9, further comprising:
generating the content input based on the composition image.

11. The method of claim 1, further comprising:
obtaining an adherence factor input that indicates a level of adherence to the composition input, wherein the synthetic image is generated based on the adherence factor input.

12. A non-transitory computer readable medium storing code for image processing, the code comprising instructions that, when executed by at least one processor, cause the at least one processor to perform operations comprising:
obtaining a composition image with a target composition; and
extracting a composition input from the composition image, wherein the composition input represents the target composition; and
generating, using an image generation model, a synthetic image based on the composition input, wherein the synthetic image depicts an image element with the target composition.

13. The non-transitory computer readable medium of claim 12, the code further comprising instructions that, when executed by the at least one processor, cause the at least one processor to perform operations comprising:
encoding the composition input to obtain a composition embedding, wherein the synthetic image is generated based on the composition embedding.

14. The non-transitory computer readable medium of claim 12, wherein:
the composition input comprises a depth map, an edge map, pose information, layout information, or any combination thereof.

15. The non-transitory computer readable medium of claim 12, wherein:
the image element comprises a style attribute, an identity of an object, a lighting attribute, a texture attribute, a scene attribute, or a combination thereof.

16. The non-transitory computer readable medium of claim 12, wherein:
the image generation model is trained to generate images depicting the image element.

17. An apparatus comprising:
at least one processor;
at least one memory;
a composition encoder comprising parameters stored in the at least one memory and configured to encode a composition input indicating a target composition to obtain a composition embedding representing the target composition; and
an image generation model comprising parameters stored in the at least one memory and configured to generate a synthetic image based on the composition embedding and a content input indicating an image element, wherein the synthetic image depicts the image element with the target composition.

18. The apparatus of claim 17, further comprising:
a text encoder configured to generate a text embedding from the content input.

19. The apparatus of claim 17, wherein:
the image generation model is trained to generate images having a plurality of different image elements based on a plurality of different nonce tokens, respectively.

20. The apparatus of claim 17, wherein:
the composition encoder comprises a ControlNet.
